(19) United States
(12) Patent Application Publication
(10) Pub. No.: US 2020/0382695 A1
(43) Pub. Date: Dec. 3, 2020

(54) ROBOT AND ELECTRONIC DEVICE FOR ACQUIRING VIDEO, AND METHOD FOR ACQUIRING VIDEO USING ROBOT

(71) Applicant: LG ELECTRONICS INC., Seoul (KR)

(72) Inventor: Juman SONG, Seoul (KR)

(73) Assignee: LG ELECTRONICS INC., Seoul (KR)

(21) Appl. No.: 16/576,122

(22) Filed: Sep. 19, 2019

(30) Foreign Application Priority Data
May 30, 2019 (KR) 10-2019-0063890

(51) Int. Cl. H04N 5/232; H04N 5/28; G06F 3/16

(52) U.S. Cl. CPC H04N 5/23219; G06F 3/165; H04N 5/28; H04N 5/23299

(57) ABSTRACT

Disclosed herein is a robot and an electronic device for acquiring video, and a method for acquiring video using the robot. The robot includes a camera configured to rotate in the lateral direction and tilt in the vertical direction, and controls at least one of a direction of the rotation of the camera, an angle of the tilt of the camera, and a focal distance of the camera by recognizing and tracking users in a video acquired by the camera.

### CROSS-REFERENCE TO RELATED APPLICATIONS

Pursuant to 35 U.S.C. § 119(a), this application claims the benefit of earlier filing date and right of priority to Korean Application No. 10-2019-0063890, filed on May 30, 2019, the disclosure of which is incorporated herein by reference in its entirety.

### BACKGROUND

### 1. Field of the Invention

The present disclosure relates to a robot and an electronic device for acquiring video, and a method for acquiring video using the robot.

### 2. Description of Related Art

Conventionally, an external supporter such as a gimbal and the like is used for video calling or recording video. That is, a user couples a device for acquiring images such as a smart phone, a camera and the like to an external supporter and then makes a video call or records video through the device for acquiring images, which is coupled to the supporter.

When making a video call or recording video, the user may displace the supporter to accurately record images of himself or herself and may use a zoom function.

However, the user has to displace the supporter manually and has to set the zoom function manually. This causes inconvenience to the user. Additionally, errors are likely to occur because the user manually displaces the supporter and sets the zoom function.

### SUMMARY OF THE INVENTION

As a means to solve the above-described problems, one objective of the present disclosure is to provide a robot and an electronic device that can make video calls or can record video without interruption by automatically tracking a user despite a change in positions of the user during the video calls or the recording of video, and a method for recording video using the robot.

Another objective of the present disclosure is to provide a method for recording video, in which sounds may be delivered in both directions by automatically allowing a camera to zoom in and out, and by adjusting gain of a microphone and volume of a speaker during video calls or recording of video, and a robot and an electronic device that can implement the method.

The objectives of the present disclosure should not be limited to what has been mentioned. Additionally, other objectives and advantages that have not been mentioned may be clearly understood from the following description and more clearly understood from embodiments. Further, it will be apparent that the objectives and advantages of the present disclosure may be implemented through means and a combination thereof in the appended claims.

As a means to achieve the above-described objectives, the robot and electronic device of the present disclosure, and the method of the present disclosure for acquiring video using the robot are characterized in that a camera which rotates in the lateral direction and tilts in the vertical direction is included and that at least one of a direction of the rotation of the camera, an angle of the tilt of the camera, and a focal distance of the camera is controlled by recognizing and tracking a user in a video acquired by the camera.

A robot according to an embodiment includes a body that rotates in the lateral direction and that tilts in the vertical direction, a camera that rotates and tilts by the rotation and tilt of the body and that acquires a video of a space, a face recognition unit that recognizes faces of one or more users in the video, a tracking unit that tracks motion of each of the recognized faces of one or more users, and a control unit that calculates sizes of the faces of one or more users, that selects a first user based on the calculated sizes of the faces, and that controls at least one of a direction of the rotation of the camera, an angle of the tilt of the camera, and a focal distance of the camera based on the tracking result of face motion of the first user.

An electronic device according to an embodiment includes a camera that rotates in the lateral direction, that tilts in the vertical direction, and that acquires a video of a space in which one or more users are positioned, a face recognition unit that recognizes faces of one or more users in the video, a tracking unit that tracks motion of each of the recognized faces of one or more users, and a control unit that calculates sizes of the faces of one or more users, that selects a first user based on the calculated sizes of the faces, and that controls at least one of a direction of the rotation of the camera, an angle of the tilt of the camera, and a focal distance of the camera based on the tracking result of face motion of the first user.

A method for acquiring video using the robot according to an embodiment includes acquiring a video of a space, in which one or more users are positioned, by a camera that rotates in the lateral direction and that tilts in the vertical direction, recognizing faces of one or more users in the video by a face recognition unit, tracking motion of each of the recognized faces of one or more users by a tracking unit, calculating sizes of the faces of one or more users by a control unit, selecting a first user based on the calculated sizes of the faces by the control unit, and controlling at least one of a direction of the rotation of the camera, an angle of the tilt of the camera, and a focal distance of the camera based on the tracking result of face motion of the first user by the control unit.

According to the present disclosure, video calling or recording of video may be provided without interruption by automatically tracking a user despite a change in positions of the user during the video calls or the recording of video.

According to the present disclosure, convenience for a user may be enhanced by automatically allowing a camera to zoom in/out, and by adjusting gain of a microphone and volume of a speaker during video calling or recording of video without intervention of the user.

Effects of the present disclosure are not limited to what has been described above, and one having ordinary skill in the art may easily draw various effects of the disclosure based on the configuration of the disclosure.

### BRIEF DESCRIPTION OF THE DRAWINGS

FIG. 1 is a view illustrating the appearance of a robot according to an embodiment.

FIG. 2 is a block diagram illustrating a control relation among major components of a robot according to an embodiment.

FIGS. 3 and 4 are flow charts illustrating a method for acquiring video using a robot according to an embodiment.

FIGS. 5 and 6 are views illustrating an example of the present disclosure, in which a user acquires video using a robot.

### DETAILED DESCRIPTION OF THE INVENTION

Hereinafter, embodiments of the present disclosure will be described in detail with reference to the drawings so that those skilled in the art to which the present disclosure pertains can easily implement the present disclosure. The present disclosure may be implemented in many different manners and is not limited to the embodiments described herein.

In order to clearly illustrate the present disclosure, technical explanation that is not directly related to the present disclosure may be omitted, and same or similar components are denoted by a same reference numeral throughout the specification. Further, some embodiments of the present disclosure will be described in detail with reference to the drawings. In adding reference numerals to components of each drawing, the same components may have the same reference numeral as possible even if they are displayed on different drawings. Further, in describing the present disclosure, a detailed description of related known configurations and functions will be omitted when it is determined that it may obscure the gist of the present disclosure.

In describing components of the present disclosure, it is possible to use the terms such as first, second, A, B, (a), and (b), etc. These terms are only intended to distinguish a component from another component, and a nature, an order, a sequence, or the number of the corresponding components is not limited by that term. When a component is described as being “connected,” “coupled” or “connected” to another component, the component may be directly connected or able to be connected to the other component; however, it is also to be understood that an additional component may be “interposed” between the two components, or the two components may be “connected,” “coupled” or “connected” through an additional component.

Further, with respect to embodiments of the present disclosure, for convenience of explanation, the present disclosure may be described by subdividing an individual component, but the components of the present disclosure may be implemented within a device or a module, or a component of the present disclosure may be implemented by being divided into a plurality of devices or modules.

A robot may denote a machine that automatically handle or operates to handle given jobs using the abilities that the robot has. Specifically, a robot that can recognize the surroundings, make its own determination, and perform operations may be referred to as an intelligent robot.

Robots may be classified into industrial ones, medical ones, domestic ones, military ones and the like depending on purposes and fields.

Robots are provided with a driving unit including an actuator or a motor such that they perform various physical motions such as a motion of their joints and the like. Additionally, movable robots are provided with wheels, brakes, propellers and the like in a driving unit such that they are driven on the road or fly in the air.

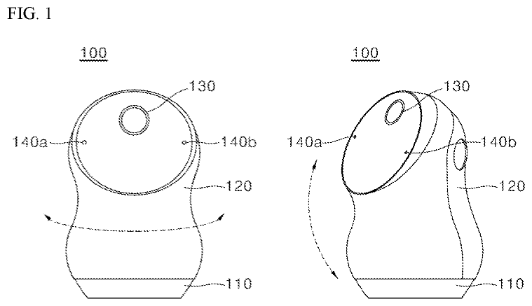

FIG. 1 is a view illustrating the appearance of a robot according to an embodiment.

Even though FIG. 1 illustrates a fixed robot 100 that does not move, the present disclosure is not limited to fixed robots and what is described below may be applied to movable robots.

Referring to FIG. 1, a robot 100 includes a first body 110 disposed on the lower side thereof, and a second body 120 disposed on the upper side of the first body 110.

The first body 110 is fixedly disposed. The second body 120 rotates on the first body 110 in the lateral direction, and angles of the second body 120 may be adjusted (i.e., tilted) in the vertical direction.

A camera 130 is attached onto the upper surface of the second body 120. Accordingly, the camera 130 rotates and tilts together with the second body 120 as the second body 120 rotates and tilts. Additionally, focal distances of the camera 130 may be adjusted, and by doing so, the camera 130 may perform a zoom function.

A microphone 140 and a speaker 150 are also attached to the second body 120. Gain of the microphone 140 may be adjusted and volume of the speaker 150 may also be adjusted.

A processor 160 and a communication unit 170 may be disposed inside the second body 120.

The processor 160 may include one or more of a central processing unit (CPU), an application processor, or a communication processor. The processor 160 may control a direction in which the second body 120 rotates and an angle at which the second body 120 tilts. Accordingly, the processor 160 may control a direction of the rotation of the camera 130 and an angle of the tilt of the camera 130. Further, the processor 160 may control focal distances of the camera 130, may also control gain of the microphone 140 and volume of the speaker 160, and may control other components of the robot 100.

The communication unit 170 communicates with external electronic devices such as external servers, external smart phones, other robots and the like.

For example, the communication unit 170 uses communication technologies such as Global System for Mobile (GSM) communications, Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, Near Field Communication (NFC) and the like.

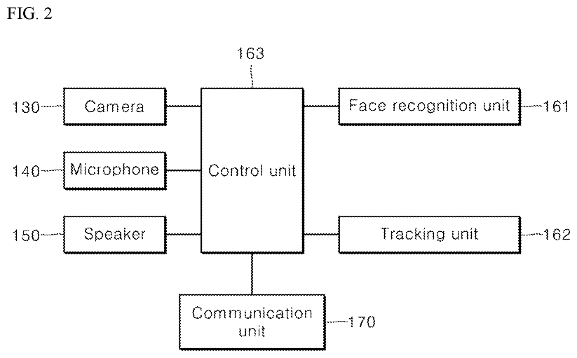

FIG. 2 is a block diagram illustrating a control relation among major components of a robot according to an embodiment.

Referring to FIG. 2, the robot 100 according to an embodiment is an electronic device that may be used to make video calls or record video, and includes a face recognition unit 161, a tracking unit 162, and a control unit (or controller)163 in addition to the camera 130, the microphone 140, the speaker 150, and the communication unit 170 that are described above.

The face recognition unit 161, the tracking unit 162, and the control unit 163 may be modules that are logically divided in the processor 160. The modules disclosed in this specification may denote a functional and structural combination of software for implementing the technical spirit of the present disclosure.

Below, functions of each of the components are specifically described.

The camera 130 acquires a video of a space. The space may refer to an indoor space or an outdoor space. The camera 130, as described above, may rotate and tilt in the lateral direction as the second body 120 rotates and tilts, and focal distances of the camera 130 may be adjusted.

The microphone 140 receives voice signal that is output in the space. The voice signal corresponds to a spoken audio that is present in the space. As described above, gain of the microphone 140 may be adjusted, and detailed description in relation to this is provided hereunder.

The speaker 150 may be used for video calls, and outputs voice signal included in video transmitted by the other person during video calls to the above-described space. Volume of the speaker 150 may be adjusted, as described above.

Control operations of the camera 130, the microphone 140, and the speaker 150 are specifically described below.

The communication unit 170 receives a video of a video call, which are transmitted by the other person and transmits a recorded video to another electronic device.

When a video of a space is recorded, the face recognition unit 161 recognizes the faces of one or more users in the video. Here, the user corresponds to a person.

The face recognition unit 161 may recognize the faces of users using a learning model that includes at least one or more artificial neural networks. The learning model may be directly learned by the face recognition unit 161 or may be learned by an external device such as an AI server and the like. In this case, the face recognition unit 161 may generate results and perform operations directly using a learning model. However, the face recognition unit 161 may also perform operations by transmitting sensor information to an external device such as an AI server and the like and by receiving results that are generated as a result.

The tracking unit 162 tracks motion of each of the recognized faces of one or more users. Like the face recognition unit 161, the tracking unit 162 may track motion of the faces of users using a learning model that includes at least one or more artificial neural networks.

According to an embodiment, the tracking unit 162 may detect land marks or skeleton features of the faces of users and may track the faces of the users based on the detected landmarks or skeleton features, concerning each of the recognized users.

In this case, an algorithm such as Kalman filters and the like may be used to track the faces of users. By doing so, the tracking unit 162 may robustly perform tracking.

The control unit 163 controls at least one of a direction of the rotation of the second body 120 and an angle of the tilt of the second body 120, i.e., at least one of a direction of the rotation of the camera 130 and an angle of the tilt of the camera 130, controls focal distances of the camera 103, and controls at least one of the gain of the microphone 140 and the volume of the speaker 150.

To this end, the control unit 163 may calculate sizes of the recognized faces of one or more users, specifically, calculate normalized sizes of the faces of users, selects a first user using the calculated sizes of the faces, and compare the sizes of the face of the first user before and after the first user's motion. The first user denotes a single user that is a main user in recording a video among one or more recognized users.

Additionally, the control unit 163 may select a first user further using voice signal of a user, which are received through the microphone 140, together with the calculated sizes of faces.

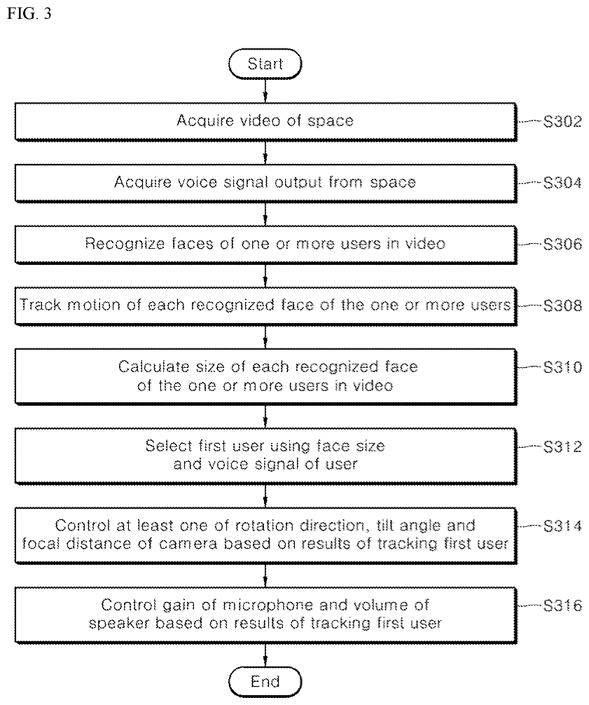

Below, embodiments of a method for acquiring video using a robot are specifically described with reference to FIG. 3.

FIG. 3 is a flow chart illustrating a method for acquiring video using a robot according to an embodiment.

Below, the method is specifically described, based on each step.

First, the camera 130 acquires a video of a space (S302), the microphone 140 acquires a voice signal that is output in the space (S304). In this case, the operations of acquiring video and voice signal may be simultaneously performed.

Next, the face recognition unit 161 recognizes faces of one or more users included in the acquired video (S306). That is, the face recognition unit 161 recognizes whether faces of users are included in the video by analyzing the acquired video. Accordingly, the face recognition unit 161 may also recognize the number of faces of one or more users. The operation of recognizing faces is performed in real time.

According to an embodiment, the face recognition unit 161 may recognize faces of users using artificial intelligence such as deep learning.

AI denotes an area that studies artificial intelligence or methodology for creating artificial intelligence, and machine learning denotes an area that studies methodology for defining various problems handled in the artificial intelligence field and for solving the problems. Machine learning is also defined as an algorithm that enhances performance concerning a certain job through steady experience in the job.

An artificial neural network (ANN) may be a model used in machine learning, and as a whole, may denote models that consist of artificial neurons (node) forming networks by a connection of synapses and that have the ability to solve problems. The artificial neural network may be defined by patterns of a connection between neurons of another layer, a learning process of renewing model parameters, and an activation function that generates output values.

The artificial neural network may include an input layer, an output layer and optionally one or more hidden layers. Each of the layers may include one or more neurons, and the artificial neural network may include synapses that connect a neuron and a neuron. In the artificial neural network, each neuron may output function values of activation functions concerning input signals that are input through synapses, weight, and deflection.

A model parameter denotes a parameter that is determined through learning, and includes weight of synaptic connections and deflection of neurons and the like. Additionally, a hyperparameter denotes a parameter that has to be set before learning, in a machine learning algorithm, and includes learning rates, repetition frequencies, mini-batch sizes, initialization functions and the like.

The objective of learning of an artificial neural network is to determine a model parameter that minimizes a loss function. The loss function may be used as an index for determining an optimal model parameter during learning of the artificial neural network.

Machine learning may be classified into supervised learning, unsupervised learning, and reinforcement learning depending on the way of learning.

The supervised learning may denote a method of making an artificial neural network learn in the state in which labels of learning data are given, and labels denote may denote the correct answers (or result values) that have to be inferred by artificial neural networks when learning data are input to the artificial neural networks. The unsupervised learning may denote a method of making an artificial neural network learn in the state in which labels of learning data are not given. The reinforcement learning may denote a method of making an agent, defined in a certain environment, learn to select an action that maximizes cumulative compensation, or the order of actions, in each state.

Machine learning that is implemented as a deep neural network (DNN) including a plurality of hidden layers among artificial neural networks is also referred to as deep learning, and deep learning is part of machine learning. Below, machine learning is construed as including deep learning.

Next, the tracking unit 162 tracks motion of each face of one or more recognized users (S308). In this case, the operation of tracking may also be performed in real time and based on artificial intelligence.

According to an embodiment, the tracking unit 162 may detect point information on landmarks of the faces of the users concerning each of the recognized users, input the detected point information on the landmarks into a Kalman filter and track the faces of the users.

Additionally, the tracking unit 162 may store the currently-detected point information on the landmarks, and may use the stored point information on the landmarks later to track the face of the user. That is, the tracking unit 162 may use the current point information on the landmarks as a feedback later to track the face of the user.

Specifically, a user may move while a video is recorded. The user may be out of a range recorded by the camera 130 at a first point in time and may be within the range recorded by the camera 130 at a second point in time after the first point in time. In this case, the tracking unit 162 has to stop tracking the face of the user during a period of time between the first point in time and the second point in time, and has to track the face of the user after recognizing the face of the user again at the second point in time.

To solve the problem, the tracking unit 162 may store point information on the landmark of a user's face, which is detected at a previous point in time near the first point in time, and use the stored point information on the landmark of the user's face when tracking at the second point in time. Accordingly, even when the user's face disappears and then appears, the tracking unit 162 may recognize the face of the same user, thereby ensuring continuity of tracking and performing no calculation process.

Next, the control unit 163 calculates a size of each of the faces of one or more recognized users in the video (S310). The size of each of the faces of one or more users is used to select a below-described first user.

For example, the control unit 163 may calculate the size of a face by calculating the length of a diagonal of the area of the recognized face, and may recognize the size of the area of the recognized face in various ways.

The control unit 163 may normalize the size of each of the faces of one or more recognized users, and may prevent errors in the operation of selecting a first user through normalization.

According to an embodiment, the control unit 163 may normalize the sizes of the faces of one or more users based on a distance between the eyes or an interocular distance (IOD).

Specifically, on the assumption that a distance between people's both eyes is the same within an error range, the control unit 163 may measure a distance between both eyes in the face area of a recognized user and may normalize the size of the face of the user based on the measured distance between both eyes.

Next, the control unit 163 selects a first user among one or more users using the size of the user's face, specifically, the normalized size of the user's face, and a voice signal received by the microphone 140 (S312).

The first user, as described above, denotes a single user that is a main user recorded in a video among one or more recognized users in the video. The process of selecting the first user performed by the control unit 163 is specifically described hereunder.

Next, the control unit 163 controls at least one of a direction of the rotation of the camera 130, an angle of the tilt of the camera 130, and a focal distance of the camera 130 based on the tracking result of face motion of the first user (S314).

According to an embodiment, the control unit 163 may control the direction of the rotation of the camera 130, and the angle of the tilt of the camera 130 such that the face of the first user and the lens of the camera 130 face each other.

Additionally, according to an embodiment, the control unit 163 may control focal distances of the camera 130 by comparing sizes of the face of the first user before and after the first user's motion.

Specifically, the control unit 163 compares size A of the face of the first user at point in time A right before the first user moves, and size B of the face of the first user at point in time B right after the first user moves.

In this case, when size A of the face is smaller than size B of the face, the control unit 163 may determine that the first user becomes closer to the camera 130, and may control a focal distance of the camera 130 such that the camera 130 zooms out. When size A of the face is larger than size B of the face, the control unit 163 may determine that the first user becomes farther from the camera 130, and may control a focal distance of the camera 130 such that the camera 130 zooms in.

Next, the control unit 163 may control gain of the microphone 140 and volume of the speaker 150 based on the tracking result of face motion of the first user (S316).

Specifically, the control unit 163 compares size A of the face of the first user at point in time A right before the first user's motion, and size B of the face of the first user at point in time B right after the first user's motion.

In this case, when size A of the face is smaller than size B of the face, the control unit 163 may determine that the first user becomes closer to the camera 130, and may control a focal distance of the camera 130 to turn down gain of the microphone 140 and volume of the speaker 150, thereby preventing unnecessary electricity consumption.

When size A of the face is larger than size B of the face, the control unit 163 may determine that the first user becomes farther from the camera 130 and then may control the microphone 140 and the speaker 150 to turn up gain of the microphone 140 and volume of the speaker 150, thereby promoting convenience of video calls for users.

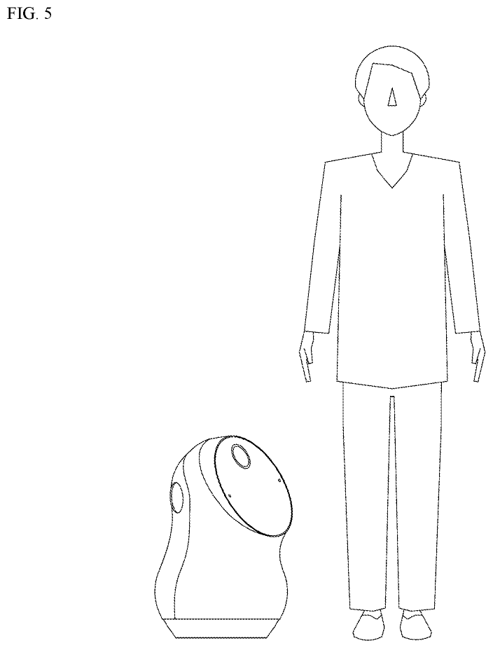

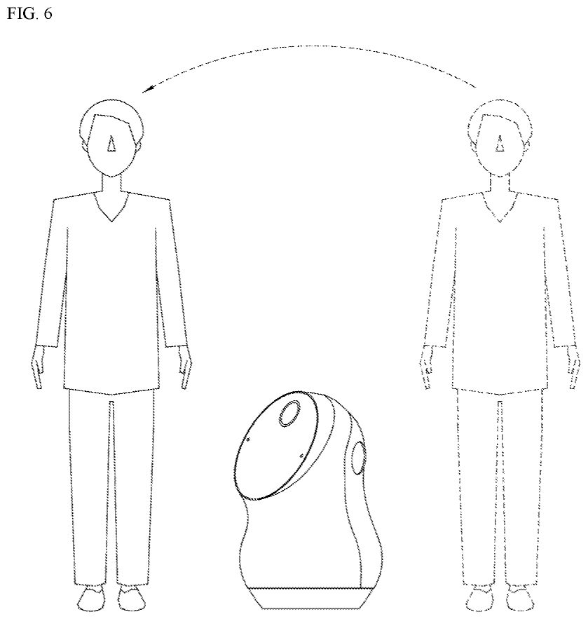

FIGS. 5 and 6 are views illustrating an example of the present disclosure, in which a user acquires video using a robot 100.

Referring to FIG. 5, the first user that is a single user is only present in a space, and the first user is on the right side of the robot 100 at the first point in time, and the robot 100 records images of the first user through the camera 130.

Referring to FIG. 6, the first user changes the first user's position and is on the left side of the robot 100 at the second point in time. The robot 100 controls a focal distance of the camera 130 based on a distance between the first user and the robot 100 while tracking the first user during a period of time between the first point in time and the second point in time, and controlling a direction of the rotation of the camera 130 and an angle of the tilt of the camera 130 such that the face of the first user and the camera 130 may face each other.

In summary, the robot 100 according to the present disclosure is a device that may rotate and tilt, and that may be used for video calling or recording of a video. Specifically, when a user makes a video call using the robot 100, the robot 100 may track the user despite a change in the position of the user. Accordingly, the user may make a video call without interruption. Additionally, the robot 100 may control gain of the microphone 140 and volume of the speaker 150 according to the position of the user, thereby solving the problem that during a video call, voices are not delivered in both directions.

Below, the step (S312) of selecting a first user is specifically described.

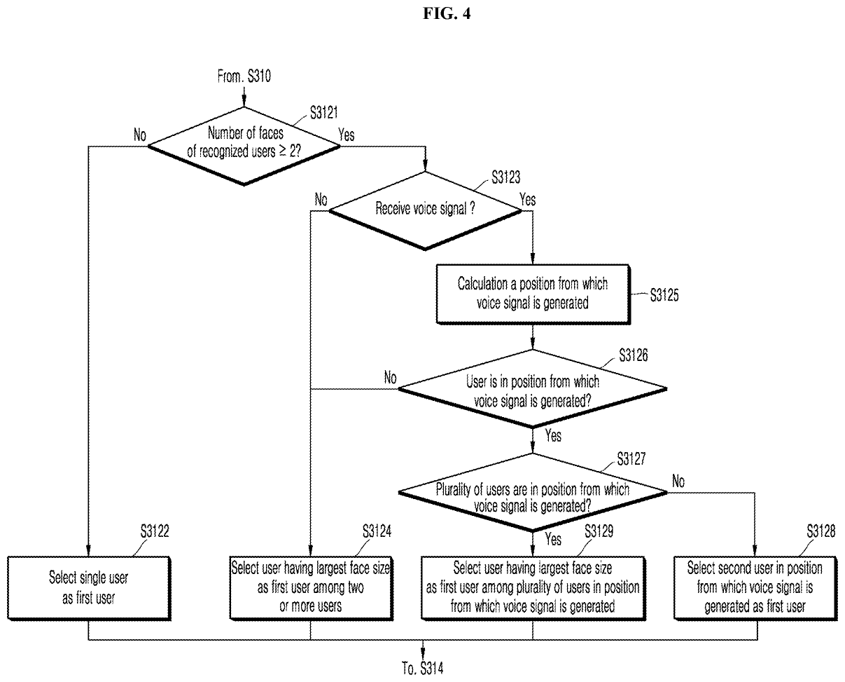

FIG. 4 is a flow chart specifically illustrating step 312 in a method for acquiring video using a robot according to an embodiment.

The control unit 163 determines whether the number of the faces of recognized users is more than two (S3121).

When the number of the face of a recognized user is one, the control unit 163 selects the single user as a first user (S3122). That is, when a single user in a video is recognized, the control unit 163 selects the single user as a first user.

When the number of the faces of recognized users is more than two, the control unit 163 determines whether voice signal is received through the microphone 140 (S3123).

If voice signal is not received, the control unit 163 selects a user having the largest face size, specifically, a user having the largest normalized face size as a first user, among two or more users (S3124).

That is, a user having the largest face size in the video is considered a user closest to the robot 100, and the user closest to the robot 100 is considered a main user recorded in the video, based on perspective. Accordingly, the control unit 163 selects a user having the largest normalized face size as a first user.

Conversely, if voice signal is received, the control unit 163 calculates a position from which voice signal is generated (S3125). In this case, the control unit 163 may determine the position from which voice signal is generated, based on artificial intelligence.

Additionally, the control unit 163 determines whether a user is in the position from which voice signal is generated (S3126). This may be performed based on the above-described process of tracking a user.

If no user is in the position from which voice signal is generated, the control unit 163, as described above, selects a user having the largest face size as a first user, among two or more users (S3124). That is, when none of the two or more users is not in the position from which voice signal is generated, it can be assumed that another user who is in the space but is not recorded in the video outputs voice signal. Accordingly, the control unit 163, as described above, may select a user having the largest face size as a first user.

If a user is in the position from which voice signal is generated, the control unit 163 determines whether a plurality of users are in the position from which voice signal is generated (S3127). That is, in step 3127, the control unit 163 determines whether a single user or a plurality of users are in the position from which voice signal is generated.

If a second user, who is a single user, is only in the position from which voice signal is generated, the control unit 163 selects the second user as a first user (S3128). That is, when the second user is in the position from which voice signal is generated, the control unit 163 determines that the second user outputs the voice signal. Accordingly, the control unit 163 may select the second user as a first user.

Conversely, if a plurality of users are in the position from which voice signal is generated, the control unit 163 selects a user having the largest face size as a first user, among the plurality of users (S3129). That is, in step 3129, the size of faces of all the users recognized in the video is not calculated but the size of the faces of the plurality of users in the position where the audio signal is generated are calculated. By doing so, the number of objects subject to the comparison of the sizes of faces is reduced. Thus, unnecessary calculation may be avoided.

The process of selecting a first user by the control unit 163 is described as follows.

When a single user is in a video, the control unit 163 may select the single user as a first user without using voice signal.

When two or more users are in a video, the control unit 163 may select a user having the largest face size as a first user, among two or more users.

The process of selecting a first user by the control unit 163 further using voice signal is described as follows.

When two or more users are in a video, and voice signal is not received, the control unit 163 may select a user having the largest face size as a first user, among two or more users.

When two or more users are in a video, voice signal is received, and no user is in a position from which the voice signal is generated, the control unit 163 may select a user having the largest face size as a first user, among two or more users.

When two or more users are in a video, voice signal is received, and a second user, who is a single user, is only in a position from which the voice signal is generated, the control unit 163 may select the second user as a first user.

When two or more users are in a video, voice signal is received, and a plurality of users are in a position from which the voice signal is generated, the control unit 163 may select a user having the largest face size as a first user, among the plurality of users.

Additionally, the embodiments of the present disclosure may be implemented in the form of a program instruction that may be performed through various computer means, and may be recorded in computer-readable media. The computer-readable media may comprise program instructions, data files, data structures and the like independently, or a combination thereof. The program instructions recorded on the media may be specially designed and configured for the present invention or the program instructions that are publicly known to those skilled in the art relating to computer software programs may be used. The examples of computer-readable media include magnetic media such as hard disks, floppy disks and magnetic tape, optical media such as CD-ROMs and DVDs, magneto-optical media such as floptical disks, and hardware devices that are specially configured to store and perform the program instructions such as Read Only Memory (ROM), Random Access Memory (RAM), flash memory and the like. The examples of program instructions include machine language code produced by a compiler as well as high-level language code executed by the computer using an interpreter and the like. The hardware devices described above may be configured to operate as one or more software modules for performing operations of the embodiments of the present invention, and vice versa. Additionally, computer programs that implement the embodiments of the present disclosure include program modules that are transmitted through external devices in real time.

The present disclosure has been described with reference to specific details such as specific components and the like, limited embodiments, and drawings. However, the details, embodiments and drawing are provided only as examples such that the disclosure may be better understood. Further, the present disclosure is not limited to the above-described embodiments and may be modified and changed by one having ordinary skill in the art to which the disclosure pertains from the embodiments. Thus, the technical spirit of the present disclosure should not be construed as being limited to the embodiments set forth herein. Rather, the embodiments are intended to cover various modifications and equivalents within the spirit and scope of the appended claims.

| [Description of Reference Numerals] | |
|---|---|
| 100: Robot | 110: First body |
| 120: Second body | 130: Camera |
| 140: Microphone | 150: Speaker |
| 160: Processor | 161: Face recognition unit |
| 162: Tracking unit | 163: Control unit |
| 170: Communication unit | |

What is claimed is:

1. A robot, comprising:
a body configured to rotate and to tilt;
a camera coupled to the body and configured to rotate and tilt according to the rotate and the tilt of the body, wherein the camera is configured to acquire a video of a space;
a face recognition unit configured to recognize respective faces of one or more persons in the video;
a tracking unit configured to track motion of each of the recognized faces of the one or more persons; and
a controller configured to:
calculate a respective size of each of the faces of the one or more persons;
select a first person, from among the one or more persons, based on the calculated sizes of the faces; and
control at least one of a direction of the rotation of the camera, an angle of the tilt of the camera and a focal distance of the camera, based on the tracked motion of the recognized face of the first person.

2. The robot of claim 1, wherein the controller is configured to:
control the direction of the rotation of the camera and the angle of the tilt of the camera to achieve an particular orientation of the camera relative to the face of the first person; and
control a focal distance of the camera by comparing respective sizes of the face of the first person before and after motion of the first person.

3. The robot of claim 2, wherein the particular orientation occurs when the camera faces a general direction of the face of the first person.

4. The robot of claim 1, wherein the controller is configured to:
normalize sizes of the faces of the one or more persons based on an interocular distance; and
select the first person based on the normalized sizes of the faces of the one or more persons.

5. The robot of claim 1, wherein the controller is configured to:
select a person having a largest face size, from among the one or more persons, as the first person.

6. The robot of claim 1, further comprising:
a microphone configured to receive a spoken audio that is present in the space;
wherein the controller is further configured to select the first person further based on the received spoken audio.

7. The robot of claim 6, wherein the controller is further configured to:
control gain of the microphone by comparing respective sizes of the face of the first person before and after motion of the first person.

8. The robot of claim 6, wherein the controller is configured to:
calculate a position from which the spoken audio is provided; and
select the first person further based on whether the one or more persons are in the position from which the voice signal is provided.

9. The robot of claim 8, wherein the controller is configured to:
select a second person as the first person, from among the one or more persons, when the second person is located in the position from which the spoken audio is provided.

10. The robot of claim 8, wherein the controller is configured to:
select a second person having a largest face size as the first person, from among the one or more persons, when none of the one or more persons is located in the position from which the spoken audio is provided.

11. The robot of claim 8, wherein the controller is configured to:
select a second person having a largest face size as the first person, from among the one or more persons, when a plurality of persons from among the one or more persons are located in the position from which the spoken audio is provided.

12. The robot of claim 1, further comprising:
a speaker,
wherein the controller is configured to:
control volume of the speaker by comparing respective sizes of the face of the first person before and after motion of the first person.

13. The robot of claim 1, wherein the body is further configured to rotate in a lateral direction, and to tilt in an vertical direction.

14. An electronic device, comprising:
a camera coupled to the body and configured to rotate and to tilt, wherein the camera is configured to acquire a video of a space within which one or more persons are positioned; and
a processor configured to:
recognize respective faces of the one or more persons in the video;
track motion of each of the recognized faces of the one or more persons;
calculate a respective size of each of the faces of the one or more persons;
select a first person, from among the one or more persons, based on the calculated sizes of the faces; and
control at least one of a direction of the rotation of the camera, an angle of the tilt of the camera and a focal distance of the camera, based on the tracked motion of the recognized face of the first person.

15. A method, comprising:
acquiring, by a camera, a video of a space within which one or more persons are positioned;
recognizing respective faces of the one or more persons in the video;
tracking motion of each of the recognized faces of the one or more persons;
calculating a respective size of each of the faces of the one or more persons;
selecting a first person, from among the one or more persons, based on the calculated sizes of the faces; and
controlling at least one of a direction of rotation of the camera, an angle of tilt of the camera and a focal distance of the camera, based on the tracked motion of the recognized face of the first person.
